(19) United States
(12) Patent Application Publication
(10) Pub. No.: US 2016/0059959 A1
(43) Pub. Date: Mar. 3, 2016

(54) ROTOR BLADE COUPLING DEVICE OF A ROTOR HEAD FOR A ROTARY-WING AIRCRAFT

(71) Applicant: Marenco Swisshelicopter AG, Pfäffikon (CH)

(72) Inventors: Martin STUCKI, Pfäffikon (CH); Mario CAMINADA, Igis (CH); Patrick Reginald MOSER, Horgen (CH)

(21) Appl. No.: 14/837,386

(22) Filed: Aug. 27, 2015

(30) Foreign Application Priority Data
Aug. 27, 2014 (CH) 01291/14
Jul. 29, 2015 (CH) 01103/15

(51) Int. Cl. B64C 27/35; B64C 27/48

(52) U.S. Cl. CPC B64C 27/35; B64C 27/48

(57) ABSTRACT

In a rotor blade coupling device for coupling with a rotor mast so as to create a rotor head of a rotary-wing aircraft, in particular a gyroplane or a helicopter, encompassing a rotor head central piece, at least two rotor blade holders fastened to the rotor head central piece for accommodating at least two rotor blades lying in a rotor plane, as well as at least one joining means between adjacent rotor blade holders, a simplified structural design is to be achieved for the rotor blade coupling device, and the rotor blade coupling device is to enable an agile control. This is achieved by virtue that the rotor blade coupling device as the joining means encompasses at least one closed ring. The ring is arranged so as to cross all rotor blade holders at least at one respective joining location, and at least indirectly join together all rotor blade holders.

### TECHNICAL AREA

The present invention relates to a rotor blade coupling device of a rotor head for a rotary-wing aircraft, for example a gyroplane or a helicopter according to the preamble of the first patent claim.

Flapping and swiveling movements arise during the rotation of rotor blades. In this conjunction, it is known that various forces act on the rotor blades, such as inertial forces, centrifugal forces, Coriolis forces and drag forces.

Rotor blade coupling devices usually encompass a rotary joint situated vertically to the rotor plane with adjustable resistance between individual rotor blade holders and a respective accompanying, lift-generating rotor blade, which allows a rearward movement, i.e., opposite the rotational direction (“lag”) of a rotor blade, or a forward movement, i.e., in the rotational direction (“lead”) of a rotor blade, in relation to a horizontal rotor plane, depending on the position of the respective rotor blade. The resistance can normally be set with hydraulic damping elements, which slow or attenuate such so-called lead-lag movements. Such lead-lag movements are primarily caused by Coriolis forces, wherein centrifugal forces, drag forces and inertial forces can also influence the lead-lag movements.

### PRIOR ART

One disadvantage long known from prior art is that stiff rotor heads are impossible or nearly impossible to design properly so as to withstand the enormous forces and torques in the rotational direction of the rotor blades during rotation.

Known in the art are helicopters with two rotor blades like the “Bell UH-1” having a semi-rigid rotor head, i.e., the two rotor blades are rigidly joined with each other. However, the rotor blades in this known “Bell UH-1” helicopter are flexibly gimballed to the rotor mast. As a consequence, the rotor blades lying in a rotor plane can only be moved up and down together in the rotor blade coupling device, comparably to a rocker. The rotor plane is tilted or inclined relative to the rotational axis running through the rotor mast by means of so-called cyclic blade adjustments. During this type of cyclic control, the adjustment angles of the rotor blades are cyclically changed as the rotor turns, and thereby exposed to a varying inflow, generating a desired inclination. This inclination produces a thrust for a horizontal movement (forward, backward, sideways) of the rotary-wing aircraft.

In this known “Bell UH-1” helicopters, torques are disadvantageously not transmitted directly into the head, which leads to a slow response time during the control process. As long as the rotor produces a significant uplift, cyclic control keeps a deflection toward the rotor mast axis low. However, excessively fast or agile control inputs, and in particular maneuvers at low G-forces, can result in significant angular misalignments or inclinations of the rotor plane relative to the rotor axis, and even lead to the feared “mast bumping”, i.e., a collision between the rotor blade arrangement and rotor mast.

Known from US 2008/0159862 A1 is another rotor blade coupling device. Document US 2008/0159862 A1 discloses a plurality of damping elements (resilient in the rotational direction of the rotating rotor blades) as joining elements between two respective adjacent rotor blades, which make up a kind of spring-mass system. The aforementioned “lead-lag” movements on the rotor head are attenuated by the damping elements from US 2008/0159862 A1.

The rotor blade coupling device with damping elements between a respective two adjacent rotor blades known from US 2008/0159862 A1 have a complicated structural design. It thus becomes necessary to provide an additional arrangement of hinges and corresponding straps at the transition between the individual damping elements and rotor blade holders, which simultaneously requires an especially high maintenance outlay.

### DESCRIPTION OF THE INVENTION

The object of the present invention is to overcome the disadvantages of the rotor blade coupling devices known from prior art, in particular to achieve a simplified structural design of a rotor blade coupling device, wherein the rotor blade coupling device is to enable agile control.

These objects are achieved by a rotor blade coupling device with the features in patent claim 1.

The rotor blade coupling device according to the invention for coupling with a rotor mast so as to create a rotor head of a rotary-wing aircraft encompasses a rotor head central piece and at least two rotor blade holders fastened thereto for accommodating and fixing at least two rotor blades lying in a rotor plane.

In addition, at least one joining means is provided between adjacent rotor blade holders.

According to the invention, the rotor blade coupling device as a joining means encompasses at least one closed ring, wherein the ring is arranged so as to cross all rotor blade holders at least at one joining section, and at least indirectly join together all rotor blade holders. In a preferred further development of the present invention, the ring crossing all rotor blade holders traverses the rotor blade holders, or the ring runs through the rotor blade holders.

The at least one ring is preferably passed through all rotor blade holders, crossing at the respective at least one joining section, and arranged so as to at least indirectly join together all rotor blade holders.

As an alternative to the ring traversing the rotor blade holders, it is possible that the ring be placed on the rotor blade holders so as to cross under or over the latter. Also conceivable according to a further development of the present invention is that the ring consist of two parts, encompassing an upper ring plate and a lower ring plate rigidly joined with the upper ring plate, and that the upper ring plate be arranged over the rotor blade holders and the lower ring plate be arranged under the rotor blade holders in such a way as to envelop the rotor blade holders as a ring with a two-part configuration.

Within the meaning of the present invention, it is understood at least indirectly that additional joining pieces can be provided between the ring and rotor blade holders, for example damping elements, etc. Such damping elements are used to diminish the mentioned lead-lag movements. Since an attenuation in the direction of the lead-lag movements is normally too weak, attenuation must be effected by means of damping elements in order to minimize vibration excitation in rotary-wing aircraft.

It was surprisingly discovered that the ring is free or nearly free of the centrifugal forces and torques caused by “blade pitching” or so-called pitch control. In addition, the ring arrangement yields a simplified structural design for a rotor blade coupling device. It is especially preferred that the ring according to the invention be circular in design, which diminishes the effect of centrifugal forces to a special extent. Alternatively, the ring according to the invention can also have a polygonal, for example pentagonal, design.

Understood by “blade pitching” or pitch control is an adjustable angle of attack for the rotor blades relative to the inflowing air, wherein pitch control takes place by turning around a “blade-pitch” angle that runs essentially in the longitudinal direction of a respective rotor blade holder or rotor blade. Reference is normally made here to a collective pitch control, when the angle of attack for all rotor blades is adjusted together and simultaneously, and the rotary-wing aircraft rises and falls as a result. Cyclic pitch control normally refers to when the angle of attack for the rotor blade is unequally actuated over the circumference, thereby changing the direction of uplift, and causing the rotary-wing aircraft to change its flight position, flight direction or flight speed.

Within the framework of this “blade-pitching” or targeted actuation of the aerodynamic angles of attack for the individual rotor blades, which most of the time is not constant during a rotation of the rotor blade, flapping movements (also referred to as “flapping”) come about. These flapping movements are understood as up and down movements of the rotor blades essentially vertical to the rotor plane, and result in Coriolis forces, wherein precisely these Coriolis forces are associated with the emergence of the described lead-lag movements.

In particular, it was found that arranging a ring in this way in the rotor blade coupling device according to the invention causes nearly all torques to be transmitted to the rotor mast, which permits especially direct and mobile or agile maneuvers.

Within the meaning of the present invention, the rotor blade coupling device according to the invention can preferably be coupled with the rotor mast of the main rotor. However, it is alternatively also conceivable that the rotor blade coupling device according to the invention be attachable to the tail rotor.

Additional advantageous embodiments are indicated in the dependent claims.

The ring is preferably composed of a material that is stiff essentially in the tangential direction, in particular in the rotational direction of the at least two rotor blades.

In a preferred further development, the ring of the rotor blade coupling device according to the invention is designed as a single piece. Alternatively, it is conceivable that the ring consist of several parts. Within the meaning of the present invention, both the one-piece ring and a multi-part ring configuration in this conjunction involve an element with a structurally rigid design.

In addition, within the meaning of the present invention, a ring designed to be stiff essentially in the tangential direction, in particular in the rotational direction, is understood to mean that the ring designed as a rigid body exhibits a resistance against elastic deformation by normally arising forces and torques that is adequate for the normal use of the rotor blade coupling device according to the invention. This type of stiff design for the ring can be achieved either by the selected material or geometry, in particular the thickness of the ring. Preferably used as materials for achieving the required stiffness of the ring are metals, e.g., aluminum, steel or titanium, or fiber composites, e.g., carbon and/or glass fiber.

The ring is preferably situated in the rotor blade coupling device in such a way that the ring and respective at least two rotor blade holders are mounted so that they can tilt relative to each other, wherein no direct mechanical operative connection exists between the ring and rotor mast with the rotor blade coupling device according to the invention coupled with the rotor head, so that the ring is completely gimballed, as it were, in several intersecting pivot bearings angled relative to each other, so that the ring functions similarly to a gimbal.

As an alternative to such a direct, mechanical operative connection between the ring and rotor mast, an attenuated connection can be established between the ring and rotor mast, as a result of which the ring continues to gimballed. It is especially preferred that the attenuated connection between the ring and rotor mast be arranged in the form of at least one, preferably radially aligned, damping device, for example a linear damper, between the ring and indirectly with the rotor head central piece coupled in a torque-proof manner with the rotor mast. In other words, it is preferred within the meaning of the present invention that no unattenuated or rigid connection be formed directly between the ring and rotor mast or indirectly between the ring and rotor head central piece. It is exceedingly preferred that the number of preferably radially aligned damping devices arranged between the ring and rotor head central piece correspond to the number of rotor blade holders, wherein it makes no difference whether a respective one, preferably radially aligned, damping device is arranged so as to run along the longitudinal direction of a respective rotor blade holder, or run at any angular distance between two adjacent rotor blade holders. In addition, for example, the preferably radially aligned damping devices can be situated in the same plane as the ring, or above or below the ring plane.

In other words, the ring preferably crosses the rotor blade holders, and is tiltably mounted in a rotor blade holder at the crossing point, which is why reference can also be made to a gimbal tilting or inclination of the ring.

In particular, the ring is situated in the rotor blade coupling device in such a way that the ring is mounted in the at least two rotor blade holders so that it can tilt around the “blade-pitch” axis. In addition, at least one rocker bearing is preferably arranged between the upper damping device and lower damping device to achieve such a tilting motion. It is especially preferred that the rocker bearing be designed as a preferably conventional slide bearing, e.g., a ball joint bearing, or as an elastomeric, spherical bearing. This rocker bearing is used to advantageously absorb the “blade-pitch” rotation, along with small angular displacements and shifts in the direction of the “blade-pitch” axis, which run in the longitudinal direction of a respective rotor blade holder.

For example, the use of a plurality of slide bearings and/or elastomer bearings makes it possible to advantageously achieve tilting motions that can take place in several axes, if necessary.

This type of arrangement causes the ring or gimbal ring to float in the rotor blade coupling device, as it were. As a result, the forces acting on a rotor blade are advantageously transmitted to all other rotor blades in nearly exactly the same way and at the same time. In other words, the ring is a structural element that joins all present rotor blade holders equally via at least one respective damping device. The possible movements of the ring or gimbal ring in the rotor blade coupling device here yield additional degrees of freedom by comparison to the known rotor blade coupling devices.

In addition, due to its gimballed, floating bearing in the rotor blade coupling device according to the invention, the ring can advantageously absorb the aforementioned flapping movements on the respective rotor blade holder or on the accompanying rotor blade.

It is further preferred that the rotor blade coupling device encompass at least one damping device between a respective rotor blade holder and the ring, wherein the damping device joins the rotor blade holder and ring. As an alternative to a damping device between a respective rotor blade holder and ring, a dampened connection can be established between the ring and rotor mast, wherein an unattenuated connection (i.e., no damping device) can in other words be formed between a respective rotor blade holder and the ring, in particular between the rocker bearing of a respective rotor blade holder and the ring. In this conjunction, it was found that, given an unattenuated connection between a respective rotor blade holder and the ring, an undesirably strong displacement of the ring out of a concentric position of the ring relative to the rotational axis of the rotor mast in the standby state can result in a non-concentric position of the ring relative to the rotational axis of the rotor mast during operation of the rotor head, wherein the excessive displacement can be at least partially compensated by the preferably radially aligned damping devices as an attenuated connection between the ring and rotor mast.

A respective rotor blade holder preferably encompasses an upper rotor blade holder plate and a lower rotor blade holder plate, wherein an upper damping device is situated between the upper rotor blade holder plate and ring, opposite from which a lower damping device is situated between the lower rotor blade holder plate and ring. In particular, the ring is thus preferably mounted in the at least two, preferably two-part rotor blade holders by means of two damping devices situated opposite each other on the ring. In other words, the ring is sandwiched, as it were, between two damping devices in the rotor blade holders.

Alternatively, a one-part damping device can be situated and configured between a respective rotor blade holder and the ring in such a way as to satisfy the stiffness and damping characteristics required during operation of the rotor head.

It is further preferred that the upper damping device encompass at least two upper rubber elements, and that the lower damping device encompass at least two lower rubber elements, with the rubber elements being situated in such a way as to attenuate the tilting motion of the tiltably mounted ring. In conjunction with the ring or gimbal ring having a stiff design in the rotational direction, a damping device with rubber elements situated in this way relative to the ring hence advantageously allows the ring to execute an attenuated tilting motion relative to a respective rotor blade holder. In other words, the rubber elements are exposed to shear stress, thereby attenuating the lead-lag movements.

The at least two rotor blade holders each preferably encompass an elastomeric, spherical bearing. It is especially preferred that the at least two elastomeric, spherical bearings be configured and situated in the rotor blade coupling device in such a way that the at least two rotor blade holders exhibit a flexible behavior when rotating in the rotational direction, and the at least two rotor blade holders can be pivoted relative to the rotor head central piece around a swiveling axis that is essentially vertical to the rotor plane with respect to a longitudinal axis of the rotor, thereby allowing “lead-lag” movements. In addition, the elastomeric, spherical bearing is designed in such a way that the elastomeric, spherical bearing exhibits a flexible behavior in the direction of the flapping movements. The elastomeric, spherical bearings are also designed to exhibit a flexible behavior in relation to “blade-pitch” rotations.

A flexible behavior of the elastomeric, spherical bearing is understood to mean a mobility in the respectively desired direction that is required for operating the rotor head.

In addition, the elastomeric, spherical bearings are preferably designed to exhibit a stiff behavior in relation to all translational displacements. Given this transitional stiffness, the at least two elastomeric, spherical bearings are in this conjunction preferably designed and situated in the rotor blade coupling device in such a way that the rotor blade holders exhibit an essentially stiff behavior in the direction of progression of the rotor axis.

The rotor head central piece preferably exhibits at least two openings, wherein each opening incorporates an elastomeric, spherical bearing.

Such elastomeric, spherical bearings advantageously cause the centrifugal load to be transmitted from a respective rotor blade holder to the rotor mast. In particular, such elastomeric, spherical bearings transmit the centrifugal force (under pressure), and allow flapping, swiveling and so-called “blade-pitch” rotations or movements. In addition, using such elastomeric, spherical bearings permits no large deformations, and prevents a collision between the rotor blade arrangement and rotor mast, i.e., a so-called “mast bumping”. Within the meaning of the present invention, the term “elastomer” is understood to mean that rubber is preferably used as the material, as a result of which the spherical bearings elastically deform when exposed to tensile and compressive loads, but thereafter return to their original, non-deformed shape again.

The stiffness of the ring is preferably significantly higher than the stiffness of the rubber elements in the damping devices and elastomeric, spherical bearings of the rotor blade holders. The advantage to this is that movements, e.g., the lead-lag movement, take place in the elastomeric, spherical bearings, or the lead-lag movements are attenuated.

A further aspect of the present invention relates to a rotor head encompassing a rotor blade coupling device according to the invention for coupling with a rotor mast. The rotor head preferably encompasses a wobble plate, wherein blade adjustment rods establish a direct operative connection between the wobble plate and at least one rotor blade holder of the rotor blade coupling device, so as to adjust an angle of attack for a rotor blade belonging to at least one rotor blade holder. The so-called blade angle of attack or “blade pitch” is determined in this way.

### BRIEF DESCRIPTION OF THE DRAWINGS

A preferred exemplary embodiment of the subject matter of the invention will be described below in conjunction with the attached drawings. Shown on:

FIG. 1 is a perspective side view of a first preferred embodiment of the rotor blade coupling device according to the invention;

FIG. 2 is a top view of a rotor blade coupling device according to the invention;

FIG. 3 is a section along A-A on FIG. 2 through a rotor blade holder of the first preferred embodiment of the rotor blade coupling device according to the invention;

FIG. 4 is a section along B-B on FIG. 2 through the rotor blade holder, damping devices and ring in the area of a recess in the ring;

FIG. 5 is a functional diagram of the first preferred embodiment of the rotor blade coupling device according to the invention;

FIG. 6 is a perspective side view of a second preferred embodiment of the rotor blade coupling device according to the invention;

FIG. 7 is a section C-C denoted on FIG. 6 through a rotor blade holder of the second preferred embodiment of the rotor blade coupling device according to the invention;

FIG. 8 is a functional diagram of the second preferred embodiment of the rotor blade coupling device according to the invention.

### DESCRIPTION

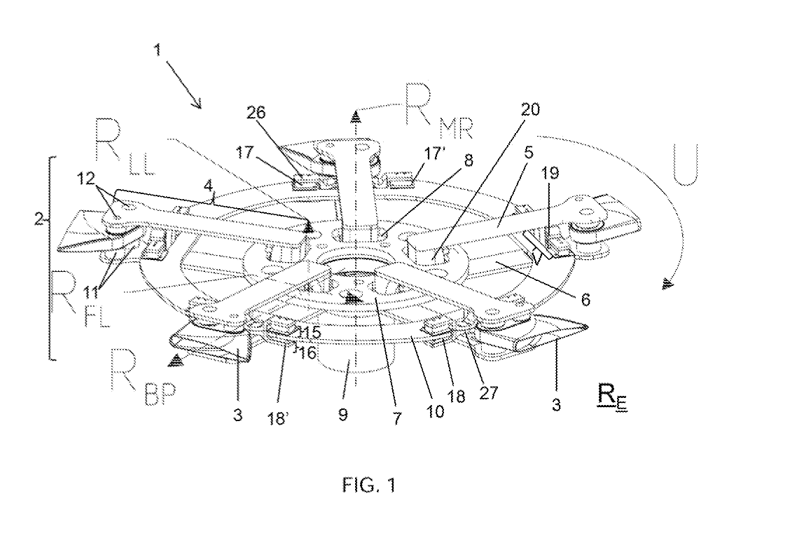

FIG. 1 shows a perspective side view of a first preferred embodiment of the inventive rotor blade coupling device 2 of a rotor head 1. Five rotor blades 3 are attached to the rotor head 1 via the rotor blade coupling device 2 according to the invention. The rotor blade coupling device 2 encompasses a rotor head central piece 7 and at least two rotor blade holders 4 secured thereto for accommodating the at least two rotor blades 3 lying in a rotor plane R_{E}. In addition, the rotor head central piece 7 designed as a disk and shown on FIG. 1 exhibits openings 8. Elastomeric, spherical bearings 20 are situated in the five openings 8 designed as an elongated hole. The rotor head central piece 7 is coupled in a torque-proof manner with a rotor mast 9 designed so that it can rotate around a rotor mast axis R_{MR}, wherein the rotor mast 9 can be made to rotate by means of a drive not shown here, and the lifting force necessary for flight is generated during rotation in a rotational direction U. The five rotor blades 3 shown in part on FIG. 1 are each joined with a rotor blade holder 4 in a torque-proof manner. The rotor blade holders 4 each encompass an upper rotor blade holder plate 5 and a lower rotor blade holder plate 6. The rotor blade holder plates 5 and 6 exhibit holes 12 for accommodating bolts 11 in an outer, radial area. The bolts 11 are used to fix a respective rotor blade 3 with the upper rotor blade holder plate 5 and lower rotor blade holder plate 6 in a torque-proof manner.

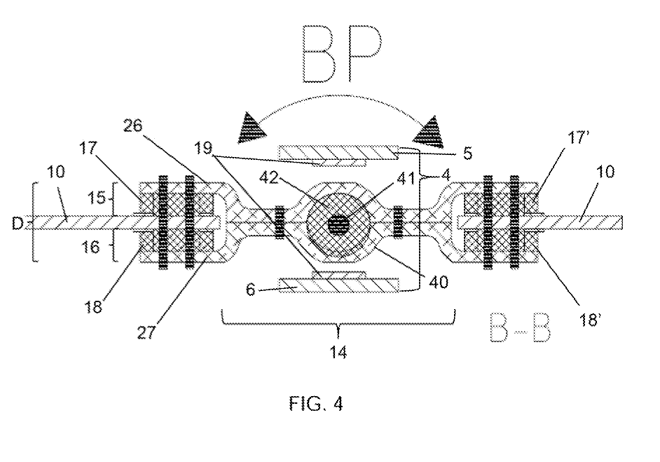

As a joining means between the blade holders 4, the rotor blade coupling device 2 shown on FIG. 1 further encompasses a closed, one-piece and circular ring 10, which is situated between the upper rotor blade holder plate 5 and lower rotor blade holder plate 6, i.e., runs through the five rotor blade holders 4 shown on FIG. 1 or crosses the rotor blade holders 4, and establishes at least an indirect connection between all five rotor blade holders 4. At the respective site where the rotor blade holders 4 cross over a connecting section V, the closed ring 10 and rotor blade holder 4 are mounted so they can tilt relative to each other. In other words, a respective rotor blade holder 4 and the ring 10 are tiltably mounted relative to each other as shown in detail on FIG. 4 in such a way that the ring does not also perform a tilting motion during a change in the blade angle of attack of the rotor blade holder 4.

As evident from FIG. 1 in this conjunction, there is no direct connection between the ring 10 and rotor mast 9, so that the ring 10 acting as a gimbal ring floats in the rotor blade coupling device 2, as it were, as a result of which forces acting on one rotor blade 3 are transmitted to all other rotor blades 3 in exactly the same way and at the same time.

The elastomeric, spherical bearings 20 are each joined with an upper rotor blade holder plate 5 and a lower rotor blade holder plate 6. Arranging the elastomeric, spherical bearings 20 in this way allows the plurality of rotor blade holders 4 to flexibly or partially swivel while rotating in the rotational direction U, while the rotor blade holders 4 exhibit an essentially stiff behavior in the direction of the rotor mast axis R_{MR}.

Situated between the upper rotor blade holder plate 5 and the ring 10 is an upper damping device 15, opposite from which a lower damping device 16 is arranged between the lower rotor holder plate 6 and the ring 10, so that the ring 10 is sandwiched, as it were, between the damping devices 15, 16 and rotor blade holder plates 5, 6. As further evident on FIG. 1, the upper damping device 15 encompasses two rubber elements 17, 17′, and the lower damping element 16 encompasses two rubber elements 18, 18′.

The angle of attack for the rotor blades 3 can be set relative to the inflowing air (so-called “blade pitching”) by turning the rotor blade holders 4 around the “blade-pitch” axis R_{BP} using a wobble plate not shown on FIG. 1 coupled with at least one blade adjustment rod not shown on FIG. 1, wherein the blade adjustment rod is in turn coupled with a respective rotor blade holder 4.

From this point on, the same reference numbers will in the following denote the same components on the figures.

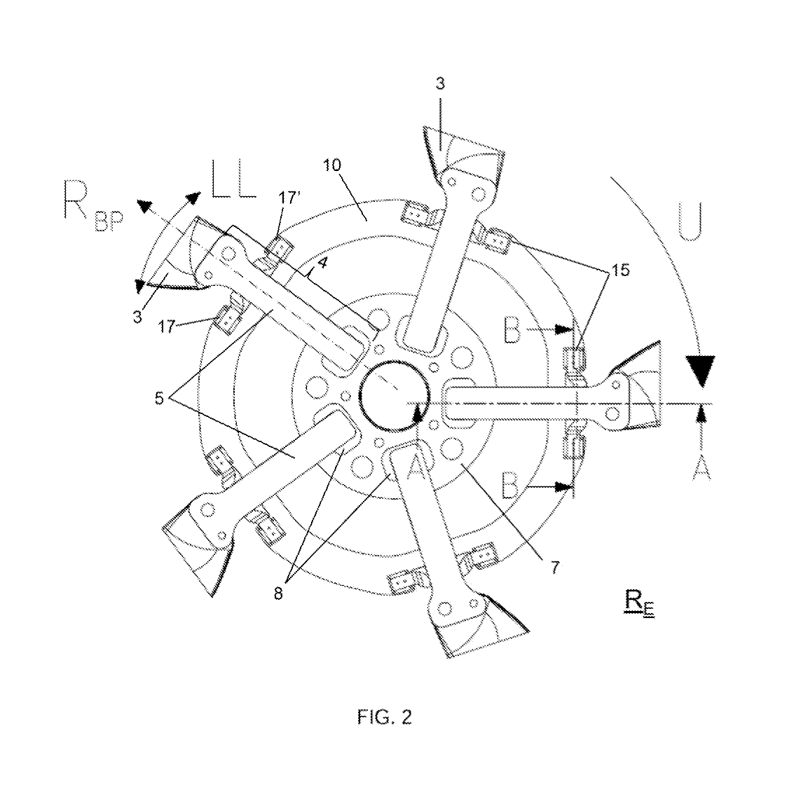

FIG. 2 shows a top view of a rotor blade coupling device 2 according to the invention. As depicted on FIG. 2, a respective upper damping device 15 is situated between the ring 10 and upper blade holder rod 5.

As denoted on FIG. 2, the elastic, spherical bearings (not visible on FIG. 2) each allow a swiveling motion LL around a swiveling axis R_{LL} in conjunction with the already described lead-lag movements arising as a function of the alignment of a rotor blade 3. The swiveling motion LL can take place in the rotor plane R_{E} in the rotational direction U (“lead”) or opposite the rotational direction U (“lag”).

In addition, the rubber elements 17, 17′ of the damping device 15 shown on FIG. 2 (as well as the rubber elements 18, 18′ of the lower damping device 16 not shown on FIG. 2) are exposed to shearing, and have an attenuating or cushioning effect on the swiveling motion LL.

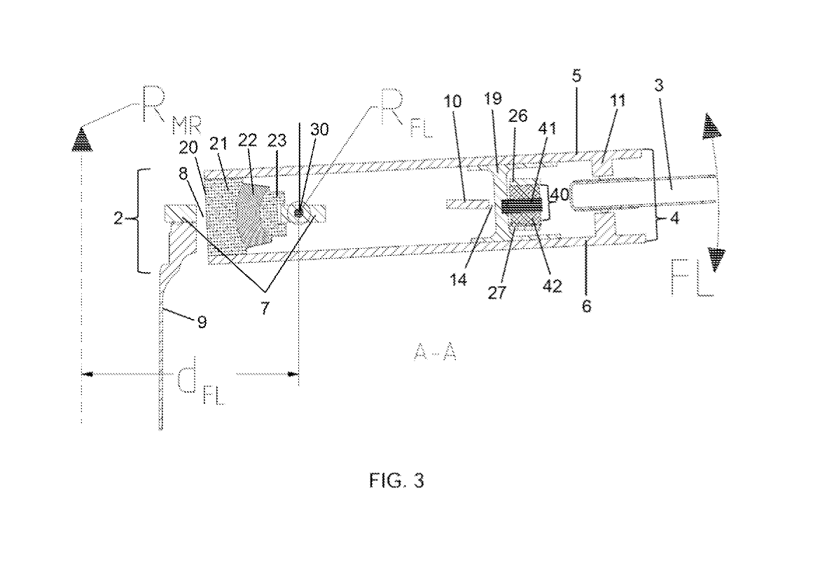

FIG. 3 schematically depicts a section A-A denoted on FIG. 2 through a rotor blade holder 4 of the rotor blade coupling device 2 according to the invention. As evident from FIG. 3, the ring 10 exhibits a recess 14 in the area of the rotor blade holder 4. Situated in the recess 14 between the upper rotor blade holder plate 5 and lower rotor blade holder plate 6 is a spacer 19, which is also rigidly connected with the rotor blade holder plates 5, 6. As further evident from FIG. 3, a rocker bearing 40 is rigidly connected with the spacer 19 on one side. Additionally evident from FIG. 3 is that a rocker bearing core 41 protruding from the rocker bearing 40 is arranged in the spacer 19, wherein the rocker bearing core 41 is firmly fixed in the spacer 19, and the rocker bearing core 41 is comprised of a stiff material. In addition, the rocker bearing 40 encompasses an elastomer 42, wherein a rubber is preferably used as the material. Such an elastomer 42 taking the form of rubber advantageously allows specific damping properties.

FIG. 3 further illustrates the structural design of the elastomeric, spherical bearing 20 situated in an opening 8 of the rotor head central piece 7. The elastomeric, spherical bearing 20 encompasses a preferably metallic bearing shell 22 in the form of a ball segment, which is arranged between an elastomer layer 21 and an elastomer layer 23. The bearing shell 22 configured as a ball segment defines a flapping axis 30 to which the bearing is rotatably mounted. The elastomeric, spherical bearing 20 is designed so flexibly for rotations around the flapping axis 30 as to permit a flapping motion FL of the respective rotor blade holder 4 or accompanying rotor blade 3. In this conjunction, because it is gimballed and floats in the rotor blade coupling device according to the invention, the ring 10 makes it possible to absorb the arising flapping motions FL on the respective rotor blade holder 4 or accompanying rotor blade 3. If the flapping axis 30 falls directly on the rotor mast axis R_{MR} or the distance d_{FL} between the rotor mast axis R_{MR} and flapping axis 30 is zero, virtually no torque is transmitted to the rotor mast. The further the flapping axis 30 of the elastomeric, spherical bearing 20 is spaced radially apart from the rotor mast 9, the higher the torque transmitted to the rotor mast 9.

FIG. 4 schematically depicts a section B-B denoted on FIG. 2 between the rotor blade holder 4, damping devices 15, 16 and ring 10 in the area of a recess 14 of the ring 10. The rocker bearing 40 is situated essentially centrally relative to the rotor blade holder 4 between the upper damping device 15 and lower damping device 16, so that the ring 10 is tiltably mounted in the respective at least two rotor blade holders 4. In other words, in the present first preferred embodiment, the rocker bearing 40 is indirectly joined with the ring 10 by way of a damping device D that encompasses the upper damping device 15 and lower damping device 16, thereby achieving an attenuating connection between a rotor blade holder 4 and the ring 10. In addition, the upper damping device 15 encompasses an upper fastening arm 26, and the lower damping device 16 encompasses a lower fastening arm 27. The fastening arms 26, 27 hold the rocker bearing 40 firmly in position, and serve to fasten the damping devices 15, 16 in the recess 14 on two opposing sides. The rocker bearing 40 can be tilted around the “blade-pitch”axis R_{BP}, as denoted by the double arrow BP, wherein the rocker bearing 40 can be a slide bearing or an elastomeric, spherical bearing or elastomer bearing. As already explained, the rocker bearing 40 is rigidly connected with a spacer 19.

In addition, FIG. 4 shows a spacer 19, wherein its structural design and arrangement between the upper rotor blade holder plate 5 and lower rotor blade holder plate 6 is evident in particular from FIG. 3.

Between the upper fastening arm 26 and the ring 10, the upper damping device 15 further encompasses the rubber element 17 on one side, and the rubber element 17′ on the opposite side. Between the lower fastening arm 27 and the ring 10, the lower damping device 16 encompasses the rubber element 18 on one side, and the rubber element 18′ on the opposite side. The rubber elements 17, 17′, 18, 18′ are exposed to shearing during the operation of the rotor head 1, which advantageously attenuates the lead-lag movement.

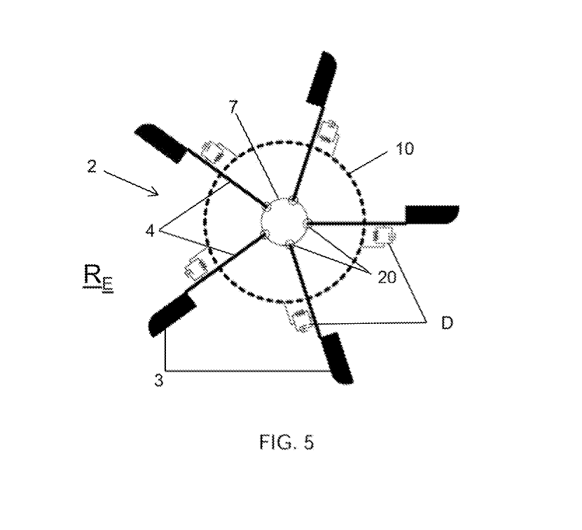

FIG. 5 shows a functional diagram of the rotor blade coupling device 2 according to the invention. Based on this functional diagram, damping devices D (e.g., the upper and lower damping devices 15, 16 shown on FIG. 4) are used to illustrate that the floating arrangement of the ring 10 in the rotor blade coupling device 2 according to the invention transmits forces acting on a respective rotor blade 3 to all other rotor blades 3 in almost exactly the same way and at the same time. In addition, FIG. 5 illustrates that no direct mechanical operative connection exists between the ring 10 and rotor mast (not denoted on FIG. 5) in a state where the rotor blade coupling device 2 according to the invention is coupled with the rotor head 1. The elastomeric, spherical bearings 20 arranged in an opening (not visible on FIG. 5) of the rotor head central piece 7 are shown as circles.

In the operating state of the rotary-wing aircraft, the rotor blades 3 are made to rotate in the rotational direction U. Using the wobble plate along with at least one blade adjustment rod coupled therewith, which is in turn coupled with a respective rotor blade holder 4, the angle of attack of the rotor blades 3 relative to the inflowing air can be set by turning the rotor blade holder 4 around R_{BP}, causing the rotary-wing aircraft to rise or fall, the so-called collective blade adjustment or “blade pitch”. The wobble plate can also be used to tilt the entire rotor plane R_{E}, generating a thrust for a horizontal movement (forward/backward/sideways) of the rotary-wing aircraft. Depending on the position of the rotor blades, inertial forces here give rise to the mentioned lead-lag movements, which can be compensated by the rotor blade coupling device 2 according to the invention.

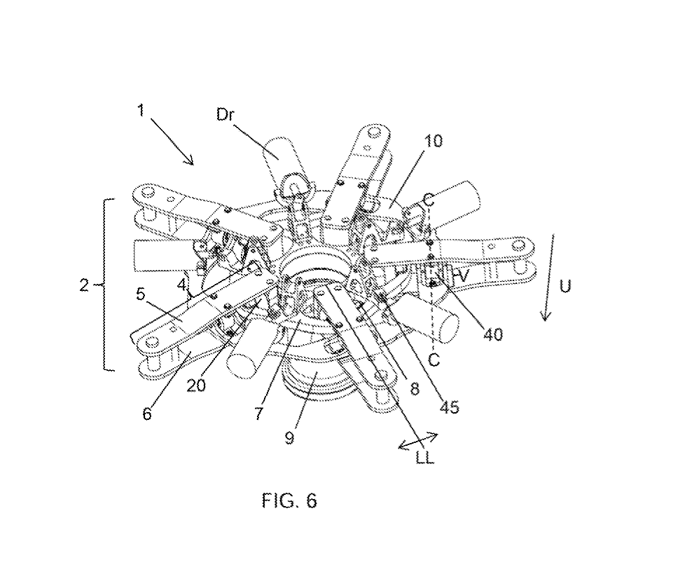

FIG. 6 shows a perspective side view of a second preferred embodiment of the rotor blade coupling device 2 according to the invention of a rotor head 1, wherein five rotor blades (not depicted on FIG. 6) can be attached to the rotor head 1 by means of the rotor blade coupling device 2 according to the invention. The rotor blade coupling device 2 shown on FIG. 6 encompasses a rotor head central piece 7 coupled in a torque-proof manner with the rotor mast 9, and rotor blade holders 4 secured thereto for accommodating rotor blades 3.

In addition, the rotor head central piece 7 designed like a disk exhibits openings 8. Situated in the five openings 8 configured as an elongated hole is a respective elastomeric, spherical bearing 20, wherein the rotor blade holders 4 can be flexibly or partially swiveled while rotating in the rotational direction U.

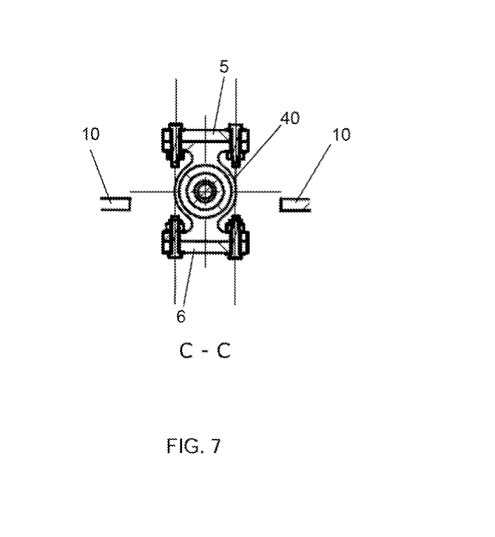

The closed ring 10 and a rotor blade holder 4 are mounted so that they can tilt relative to each other at the location where the rotor blade holders 4 cross over a connecting section V. In the connecting section V, the closed ring 10 here exhibits a recess 14 in the form of an elongated hole, in which is situated a rocker bearing 40. The rocker bearing 40 of a blade holder 4 is unattenuated and directly joined with the ring in this second preferred embodiment (in this respect, see also FIG. 7). In addition (as compared to the rocker bearing 40 of the first embodiment), the rocker bearing 40 in the second preferred embodiment preferably exhibits a configuration that ensures that the ring of the rotor blades can be displaced.

As also evident from FIG. 6, radially arranged and aligned damping devices Dr are situated between the rotor blade central piece 7 coupled in a torque-proof manner with the rotor mast 9 and the ring 10, e.g., as viewed in the rotational direction U centrally to a respective two adjacent rotor blade holders 4, as a result of which, to put it another way, a damped connection is provided between the ring and rotor mast, and the floating ring is gimballed. The radially aligned attenuating devices Dr are spherically mounted on the end side by means of a respective first ball joint 45 on the rotor head central piece 7 and a second ball joint (not visible on FIG. 6) on the ring 10. The damping device Dr is a linear damper.

FIG. 7 shows a section C-C through a rotor blade holder of the second preferred embodiment of the rotor blade coupling device 2 according to the invention shown on FIG. 6. As evident from FIG. 7, the rocker bearing 40 in the second preferred embodiment is operatively connected directly with the upper rotor blade holder plate 5 and lower rotor blade holder plate 6, as opposed to the first preferred embodiment. Also evident from FIG. 7 is that, as opposed to the first preferred embodiment (see FIG. 4), no damping connection is established between a respective rotor blade holder 4 and the ring 10 in the second preferred embodiment.

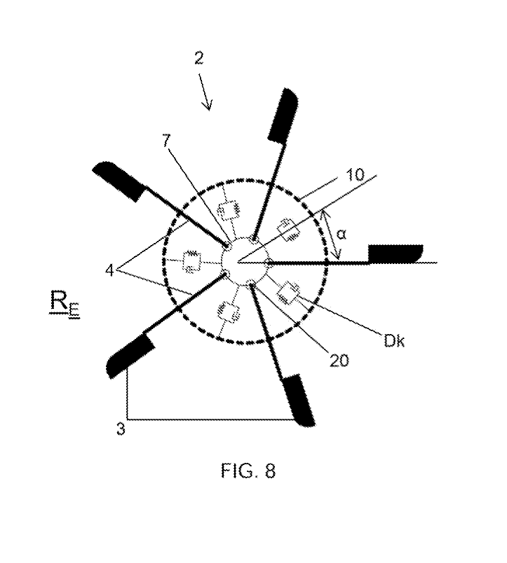

In addition, FIG. 8 shows a functional diagram of the second preferred embodiment of the rotor blade coupling device 2 according to the invention. The elastomeric, spherical bearings 20 arranged in an opening (not visible on FIG. 8) of the rotor head central piece 7 are depicted as circles. In particular, FIG. 8 shows that only the radial damping devices Dr allow a direct mechanical connection to exist between the ring 10 and the rotor head central piece rigidly joined with the rotor mast (not denoted on FIG. 8), and that the ring is floatingly arranged. The angular distance a between a blade holder 4 and a radial damping device Dr can be as desired.

### REFERENCE LIST

1 Rotor head
2 Rotor blade coupling device
3 Rotor blade
4 Rotor blade holder
5 Upper rotor blade holder plate
6 Lower rotor blade holder plate
7 Rotor head central piece
8 Opening
9 Rotor mast
10 Ring
11 Bolt
12 Holes
14 Recess
15 Upper damping device
16 Lower damping device
17, 17′ Upper rubber elements
18, 18′ Lower rubber elements
19 Spacer
20 Elastomeric, spherical bearing
21 Elastomer layer
22 Bearing shell
23 Elastomer layer
26 Upper fastening arm
27 Lower fastening arm
30 Flapping axis
40 Rocker bearing
41 Rocker bearing core
42 Elastomer
45 First ball joint
BP Blade pitching
D Damping device
Dr Radial damping device (ring)
FL Flapping movement
V Connecting section
R_{LL} Swiveling axis
R_{E} Rotor plane
R_{MR} Rotor mast axis
R_{BP} “Blade-pitch” axis
d_{FL} Distance (flapping axis)

1. A rotor blade coupling device for coupling with a rotor mast so as to create a rotor head of a rotary-wing aircraft, in particular a gyroplane or a helicopter, encompassing
a rotor head central piece,
at least two rotor blade holders fastened to the rotor head central piece for accommodating at least two rotor blades lying in a rotor plane, as well as
at least one joining means between adjacent rotor blade holders,
wherein
the rotor blade coupling device as the joining means encompasses at least one closed ring, wherein the at least one ring is arranged so as to cross all rotor blade holders at least at one joining section, and at least indirectly join together all rotor blade holders.

2. The rotor blade coupling device according to patent claim 1,
wherein
the at least one ring is passed through all rotor blade holders, crossing at the respective at least one respective joining section, and arranged so as to at least indirectly join together all rotor blade holders.

3. The rotor blade coupling device according to patent claim 1,
wherein
the ring is composed of a material that is stiff essentially in the tangential direction, in particular in the rotational direction of the at least two rotor blades.

4. The rotor blade coupling device according to claim 1,
wherein
the ring is situated in the rotor blade coupling device in such a way that the ring and respective at least two rotor blade holders are mounted so that they can tilt relative to each other.

5. The rotor blade coupling device according to claim 1,
wherein
the rotor blade coupling device encompasses at least one damping device between a respective rotor blade holder and the ring.

6. The rotor blade coupling device according to patent claim 5,
wherein
a respective rotor blade holder encompasses an upper rotor blade holder plate and a lower rotor blade holder plate, wherein an upper damping device is situated between the upper rotor blade holder plate and ring, opposite from which a lower damping device is situated between the lower rotor blade holder plate and ring.

7. The rotor blade coupling device according to patent claim 6,
wherein
the upper damping device encompasses at least two upper rubber elements and the lower damping device encompasses at least two lower rubber elements, and that the rubber elements are situated in such a way as to attenuate the tilting motion of the tiltably mounted ring.

8. The rotor blade coupling device according to claim 1,
wherein
an attenuated connection is established between the ring and rotor mast.

9. The rotor blade coupling device according to claim 1,
wherein
the at least two rotor blade holders each encompass an elastomeric, spherical bearing.

10. The rotor blade coupling device according to patent claim 9,
wherein
the at least two elastomeric, spherical bearings are configured and situated in the rotor blade coupling device in such a way that the at least two rotor blade holders exhibit a flexible behavior when rotating in the rotational direction, and the at least two rotor blade holders can be pivoted relative to the rotor head central piece around the swiveling axis.

11. The rotor blade coupling device according to patent claim 9,
wherein
the rotor head central piece exhibits at least two openings, wherein each opening incorporates an elastomeric, spherical bearing.

12. A rotor head encompassing a rotor blade coupling device for coupling with a rotor mast according to claim 1.

13. The rotor head according to patent claim 12,
wherein
the rotor head encompasses a wobble plate, wherein
the wobble plate is directly operatively connected with at least one rotor blade holder of the rotor blade coupling device, and is designed and situated so as to adjust an angle of attack for a rotor blade belonging to at least one rotor blade holder.
